(19) United States
(12) Patent Application Publication
(10) Pub. No.: US 2026/0323282 A1
(43) Pub. Date: Oct. 15, 2026

(54) SYSTEMS AND METHODS FOR UTILIZING PROOF OF LOCATION FOR IMPROVED RESOURCE ACCESS

(71) Applicant: Wells Fargo Bank, N.A., San Francisco, CA (US)

(72) Inventor: Matthew N. Wheeler, Charlotte, NC (US)

(21) Appl. No.: 19/174,534

(22) Filed: Apr. 9, 2025

(51) Int. Cl. H04W 12/06; H04W 12/64

(52) U.S. Cl. CPC H04W 12/06; H04W 12/64

(57) ABSTRACT

Systems, apparatuses, methods, and computer program products are disclosed for utilizing proof of location for improved resource access. An example method includes receiving, by communications hardware and from a remote device, a resource request comprising a plurality of attributes relating to a user including a first attribute indicating a first address of the user. The example method further includes receiving, by the communications hardware and via a GPS chip of the remote device, current location data associated with the remote device. The example method further includes determining, by an authentication engine, whether the current location data is within a predefined proximity to the first address. The example method further includes facilitating, by a resource management engine, access to a first electronic resource based at least on the determination.

### BACKGROUND

An imposter may learn personal information about another person in order to open and/or gain access to resources in that person's name for nefarious purposes. Thus, relying on knowledge factors alone when attempting to verify someone's identity is not sufficient.

### BRIEF SUMMARY

Digital payments, mobile banking, and contactless transactions have become increasingly prevalent. Many people opt to perform various tasks from the comfort of their home through their personal electronic devices out of convenience or in some cases, necessity. As one example, a person may open a new electronic resource, such as a checking account or line of credit, simply by inputting personal information into an online portal, which the bank then verifies. If significant discrepancies are found in the inputted information, the bank may require the person to visit a brick-and-mortar branch in order to provide further proof of identity (e.g., a physical identification card, etc.).

However, new customers may be dissuaded from opening an account (or other resource) if they are required to visit a physical bank branch. Such a trip may inconvenience a prospective customer or be difficult to achieve due to accessibility issues and/or residing a long distance away from the nearest branch. On the other hand, however, banks need to verify the identity of their customers due to various Know-Your-Customer (KYC) requirements. KYC guidelines and regulations in financial services require professionals to verify the identity, suitability, and risks involved with maintaining a business relationship with a customer.

Traditionally, it has been difficult to verify the identity of an individual during the account opening process without an in-person meeting and review of physical identifying documents. In contrast to these conventional techniques for verifying identities of customers and facilitating resources (e.g., accounts) to them, example embodiments described herein utilize proof of location for improved resource access. The present disclosure sets forth systems, computer-implemented methods, and apparatuses that leverage location data (both current, real-time location data and historical location data) from remote devices to determine whether to facilitate access to an electronic resource requested by the remote devices. For example, in some embodiments, a resource system may intelligently compare the location data received via a Global Positioning System (GPS) chip of a remote device to the addresses provided in a new account request to determine whether a new account can be opened for a user.

In some embodiments, the resource system may receive a resource request from a remote device. In some examples, this resource request may be for a net-new user (e.g., a prospective customer previously unaffiliated with the bank) or an existing user (e.g., an existing customer having an established relationship with the bank). In some embodiments, in addition to the resource request, the remote device may, in real-time, provide current location data of the remote device used to submit the resource request. In addition to current location data, the resource system may retrieve historical location data of the remote device over a time window (e.g., from the remote device or from a third-party service that has this information). For example, the system may gather historical location data of the remote device over a specified time period (e.g., the previous 30-90 days).

In various embodiments, the utilization of location data may be part of a larger resource grant determination process performed by the resource system which involves determining a user identity confidence score for the resource request. The user identity confidence score may indicate a confidence level that the user for whom the resource request is being made is actually the person requesting the new resource from the remote device. In some embodiments, this resource grant determination process may comprise cross-checking attributes of the user provided in the resource request with one or more external data sources (e.g., third-party entities such as credit bureaus and/or the like) to ensure accuracy of information.

In some embodiments, if the resource system determines that discrepancies exist in the resource request, the resource system may utilize location data to enhance the determination as to whether the user for whom the resource request is being made is actually the person requesting the new resource from the remote device. For example, in some embodiments, the resource system may determine whether the received current location data of the remote device is consistent with the address provided as the home address for the user associated with the user device (i.e., that the user is currently present or has consistently been present at the residential address provided in the new account request). Additionally, in some embodiments, the resource system may determine whether historical location data received from the remote device indicates that the remote device is or has been consistently present at a secondary address (e.g., a work address) known to be associated with the person for whom the new account request is intended. In some embodiments, the resource system may update the user identity confidence score based on the determination as to whether the location data syncs up with one or more addresses of the intended user. In various embodiments, the resource may further update or modify the user identity confidence score based on other features included in the location data, such as the consistency of patterns within the location data. In some embodiments, if the user identity confidence score satisfies a threshold value, the resource system may authorize access to the requested resource (e.g., a user account opening) without requiring the user to visit a physical branch location or perform additional authentication procedures.

There are many advantages of these and other embodiments described herein. For instance, the possibility of fraudulent account openings or other resource access is greatly reduced. In this regard, not only would a fraudster have to possess and submit accurate information on another individual in the resource request (checking against credit bureaus and/or other external data sources for accurate addresses and other credible personally identifiable information (PII)), the fraudster would also need to physically be present at the credible home address at the time of submitting the resource request in order to pass the real-time location data check. Thus, the economics of fraud schemes that rely on merely standing outside another individual's home fail to scale, as this would require an impractical number of people constantly traveling to different locations, making it cost-prohibitive.

In addition, as the resource system obtains location data directly via a GPS chip of a remote device, fraud attempts are made far more challenging as GPS data is significantly harder to spoof than other techniques such as deriving coordinates from an Internet Protocol (IP) address or the like. For instance, IP-based location can be manipulated through Virtual Private Networks (VPNs) or proxies with little effort, whereas spoofing GPS data requires far more sophisticated techniques. Further, use of location data from a GPS chip improves computational efficiency through reducing reliance on resource-intensive IP address derivation techniques (e.g., which may involve IP lookup databases and requiring cross-referencing multiple data sources to estimate a current location). In this regard, using GPS data results in fewer false positives, less processing power spent on verification, and optimal computational resource allocation. Example embodiments described herein provide a technical, scalable, and reliable means for accurately verifying identity through GPS-based location data. To this end, accurately verifying real-time location using a GPS chip cannot be done through purely human processes because it requires precise satellite-based triangulation, real-time data retrieval from a remote device, and digital authentication, all of which are tasks far beyond human calculation speed. Unlike humans, computers can instantly process GPS signals, validate coordinates, and make determinations as to whether the location is within range of an expected location, thus making the process scalable and extremely resistant to fraud.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates an example environment in which some example embodiments may be used.

FIG. 2A illustrates a schematic block diagram of example circuitry embodying a resource system device that may perform various operations in accordance with some example embodiments described herein.

FIG. 2B illustrates a schematic block diagram of example circuitry embodying a remote device that may perform various operations in accordance with some example embodiments described herein.

FIG. 3 illustrates an example flowchart for utilizing proof of location for improved resource access, in accordance with some example embodiments described herein.

FIG. 4 illustrates an example flowchart for an example resource grant determination process, in accordance with some example embodiments described herein.

FIG. 5 illustrates an example flowchart for modifying a user identity confidence score based on a historical location dataset, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

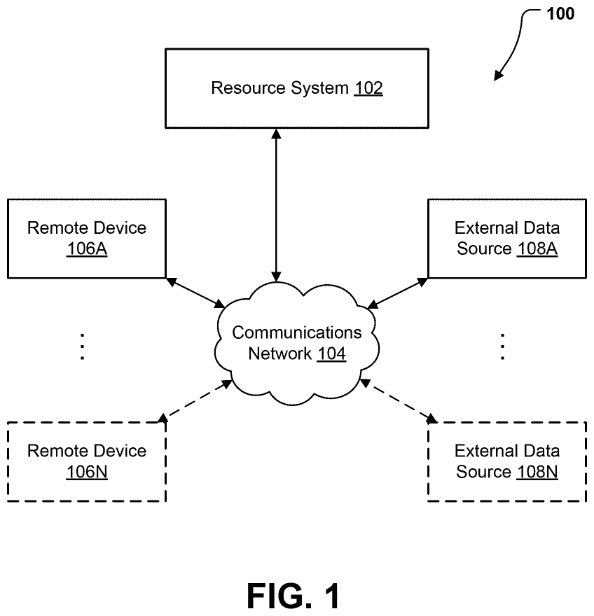

Example embodiments described herein may be implemented using any of a variety of computing devices or servers. To this end, FIG. 1 illustrates an example environment 100 within which various embodiments may operate. As illustrated, a resource system 102 may receive and/or transmit information via communications network 104 (e.g., the Internet) with any number of other devices, such as one or more of remote devices 106A-106N and/or external data sources 108A-108N.

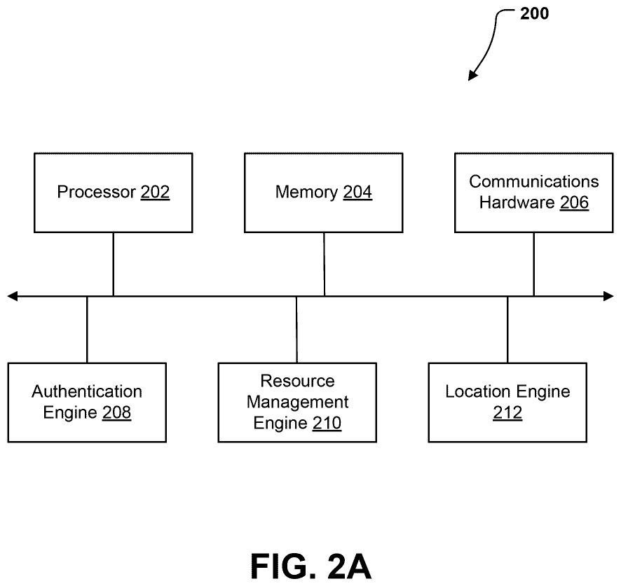

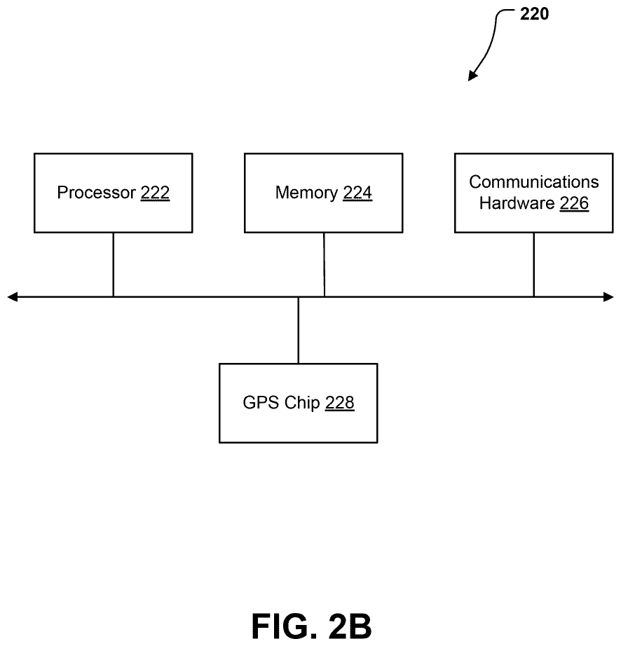

The resource system 102 may be implemented as one or more computing devices or servers, which may be composed of a series of components. Particular components of the resource system 102 are described in greater detail below with reference to apparatus 200 in connection with FIG. 2A.

In some embodiments, the resource system 102 may further include a storage device that comprises a distinct component from other components of the resource system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the resource system 102. The storage device may store information relied upon during operation of the resource system 102, such as various location data that may be used by the resource system 102, data and documents to be analyzed using the resource system 102, or the like. In addition, the storage device may store control signals, device characteristics, and access credentials enabling interaction between the resource system 102 and one or more of the remote devices 106A-106N or external data sources 108A-108N.

The one or more remote devices 106A-106N and the one or more external data sources 108A-108N may be embodied by any computing devices known in the art. The one or more remote devices 106A-106N and the one or more external data sources 108A-108N need not themselves be independent devices, but may be peripheral devices communicatively coupled to other computing devices. In various embodiments, external data sources 108A-108N may comprise computing devices outside of an organization (e.g., a financial institution such as a bank) associated with the resource system 102 which are managed by other entities designed to provide credible information for verification and decision-making. For example, external data sources 108A-108N may include computing devices associated with credit bureaus, government databases, and/or other trusted entities that store and provide PII as needed. In some embodiments, external data sources 108A-108N may also comprise one or more geolocation databases or devices configured to provide geolocation data for geocoding operations conducted by location engine 212 as further discussed below. Particular components of an example remote device (e.g., any of remote devices 106A-106N) are described in greater detail below with reference to apparatus 220 in connection with FIG. 2B.

### Example Implementing Apparatuses

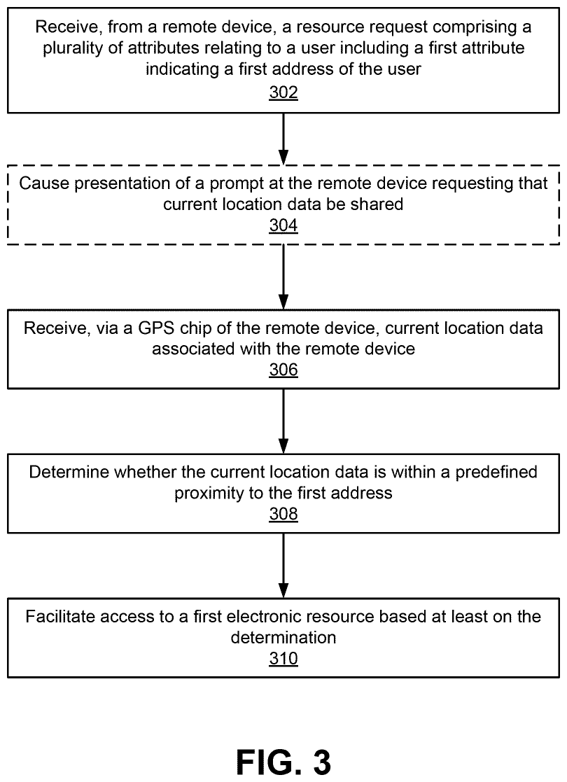

The resource system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-5. As illustrated in FIG. 2A, the apparatus 200 may include processor 202, memory 204, communications hardware 206, authentication engine 208, resource management engine 210, and location engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an authentication engine 208 that determines and updates or modifies user identity confidence scores, as further described herein. To do so, authentication engine 208 may query external data sources to obtain credible user data as a basis to determine or update a user identity confidence score. Additionally, in some embodiments, authentication engine 208 may determine whether current location data is within a predefined proximity to an address supplied in a resource request, and/or whether a remote device was within a predefined proximity to one or more addresses at least a predefined number of times over a predefined time period using a historical location dataset. The authentication engine 208 may utilize processor 202, memory 204, or any other hardware component included in the apparatus 200 to perform these operations, as described in connection with FIGS. 3-5 below. The authentication engine 208 may further utilize communications hardware 206 to gather data from (and transmit data to) a variety of sources (e.g., any of remote devices 106A-106N and/or any of external data sources 108A-108N as shown in FIG. 1).

In addition, the apparatus 200 further comprises a resource management engine 210 that executes a resource grant determination process using at least information supplied in a resource request and facilitates access to electronic resource(s) based on various criteria, as further described herein. The resource management engine 210 may utilize processor 202, memory 204, or any other hardware component included in the apparatus 200 to perform these operations, as described in connection with FIGS. 3-5 below. The resource management engine 210 may further utilize communications hardware 206 to gather data from (and transmit data to) a variety of sources (e.g., remote devices 106A-106N and/or external data sources 108A-108N, as shown in FIG. 1).

Further, the apparatus 200 further comprises a location engine 212 that converts textual address data into a spatial coordinate format. To do so, location engine 212 may utilize one or more geocoding techniques as further discussed herein. The location engine 212 may utilize processor 202, memory 204, or any other hardware component included in the apparatus 200 to perform these operations, as described in connection with FIGS. 3-5 below. The location engine 212 may further utilize communications hardware 206 to gather data from (and transmit data to) a variety of sources (e.g., remote devices 106A-106N and/or external data sources 108A-108N, as shown in FIG. 1).

Although components 202-212 are described in part using functional language, it will be understood that the particular implementations necessarily include the use of particular hardware. It should also be understood that certain of these components 202-212 may include similar or common hardware. For example, the authentication engine 208, resource management engine 210, and location engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “engine” with respect to elements of the apparatus therefore shall be interpreted as necessarily including the particular hardware configured to perform the functions associated with the particular element being described. Of course, while the term “engine” should be understood broadly to include hardware, in some embodiments, the term “engine” may in addition refer to software instructions that configure the hardware components of the apparatus 200 to perform the various functions described herein.

Although the authentication engine 208, resource management engine 210, and location engine 212 may leverage processor 202, memory 204, or communications hardware 206 as described above, it will be understood that any of authentication engine 208, resource management engine 210, and location engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that authentication engine 208, resource management engine 210, and location engine 212 comprise particular machinery designed for performing the functions described herein in connection with such elements of apparatus 200.

As illustrated in FIG. 2B, an apparatus 220 is shown that represents an example remote device (e.g., any of remote devices 106A-106N). The apparatus 220 includes processor 222, memory 224, and communications hardware 226, each of which is configured to be similar to the similarly named components described above in connection with FIG. 2A. However, the apparatus 220 also includes GPS chip 228, which includes hardware components designed to receive and process signals from satellite systems (e.g., Global Navigation Satellite Systems (GNSS)) to determine location data for the remote device at a given time.

In various embodiments, GPS chip 228 may comprise an integrated circuit that receives signals from GNSS such as, for example, GPS, Galileo, and other similar systems. While referred to as a “GPS” chip herein, it is to be appreciated that the GPS chip 228 may receive and process signals from systems other than GPS. GPS chip 228 may of a certain type, depending on the type of remote device or other considerations. In some embodiments, GPS chip 228 may be a hybrid positioning chip that combines GNSS location functionality with Wi-Fi signals, cellular network signals, and/or the like as well as inertial sensors of the remote device (e.g., gyroscope, accelerometer, etc.) to produce more reliable location data (including in instances in which satellites are not available or the satellite signals are weak. In some embodiments, GPS chip 228 may comprise a standalone GPS chip which operates independently of other sensors or modules of the remote device and directly processes GNSS signals to determine current location of the remote device. In some embodiments, GPS chip 228 may comprise an assisted GPS (A-GPS) chip that utilizes proximity to cellular base stations to determine current location of the remote device. In some embodiments, GPS chip 228 may comprise a multi-GNSS chip which is configured to process signals from some combination of GNSS satellites (e.g., including a combination of GPS, Galileo, and BeiDou). Regardless of the exact type of GPS chip, GPS chip 228 may process signals from one or more satellites to determine a precise location of the remote device in real-time. In various embodiments, this location data can be transmitted to resource system 102 for further processing as described herein.

In various embodiments, GPS chip 228 may comprise an antenna (e.g., GNSS antenna) which captures satellite signals (including time and orbital data) on certain frequency bands, and a chipset which processes the received signals, provides error correction, and determines a real-time current location of the remote device. The GPS chip 228 may utilize processor 222, memory 224, or any other hardware component included in the apparatus 220 to perform these operations, as described in connection with FIGS. 3-5 below. The GPS chip may further utilize communications hardware 226, processor 222, and/or memory 224 to cause transmission of current location data to resource system 102. For example, in some embodiments, GPS chip 228 may interface with processor 222 to format current location data into a spatial coordinate format that includes, for example, latitude, longitude, altitude, timestamp, etc. In some embodiments, apparatus 220 may then transmit the current location data to resource system 102 using communications hardware 226 over communications network 104. In some embodiments, the current location data may be secured prior to transmission via a protocol such as Transport Layer Security (TLS) or the like to prevent tampering. In this regard, in some embodiments, resource system 102 may process received current location data from a remote device for anomalies prior to additional operations to ensure authenticity of the data.

In some embodiments, various components of the apparatuses 200 and 220 may be hosted remotely (e.g., by one or more cloud servers) and thus need not physically reside on the corresponding apparatus 200 or 220. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2A or apparatus 220 as described in FIG. 2B, that loading the software instructions onto a computing device or apparatus produces a special-purpose machine comprising the means for implementing various functions described herein.

Having described specific components of example apparatuses 200 and 220, example embodiments are described below in connection with a series of flowcharts.

### Example Operations

Turning to FIGS. 3-5, example flowcharts are illustrated that contain example operations implemented by example embodiments described herein. The operations illustrated in FIGS. 3-5 may, for example, be performed by a system device of the resource system 102 shown in FIG. 1, which may in turn be embodied by an apparatus 200, which is shown and described in connection with FIG. 2A. To perform the operations described below, the apparatus 200 may utilize one or more of processor 202, memory 204, communications hardware 206, authentication engine 208, resource management engine 210, location engine 212, and/or any combination thereof. It will be understood that user interaction with the resource system 102 may be facilitated by a separate remote device 106A-106N, as shown in FIG. 1 and FIG. 2B, for example, and which may have similar or equivalent physical componentry facilitating such user interaction as described above.

Turning first to FIG. 3, example operations are shown for utilizing proof of location for improved resource access.

As shown by operation 302, the apparatus 200 includes means, such as processor 202, memory 204, communications hardware 206, and/or the like, for receiving, from a remote device, a resource request comprising a plurality of attributes relating to a user including a first attribute indicating a first address of the user.

In some embodiments, a remote device (e.g., any of remote devices 106A-106N) may generate a resource request via a mobile application stored on the remote device (e.g., in memory 224). For example, in some embodiments in which resource system 102 is managed by or otherwise associated with a financial institution, a remote device may interact with resource system 102 via a mobile banking application. In some embodiments, a mobile banking application comprises a software application that allows users to manage their personal banking resources, perform transactions and money transfers, and apply for various banking resources (e.g., accounts, loans, lines of credit, etc.). In some embodiments, a mobile banking application may integrate with various systems of a financial institution through Application Programming Interfaces (APIs) in order to send and receive data. Through a mobile banking application, a user may input attributes (e.g., PII) about themselves in order to prove their identity to resource system 102 when attempting to be approved for a resource.

In some embodiments, a resource request may be a request to obtain or access an electronic resource from the financial institution. As one example, a resource request may be submitted by a user (via their personal remote device) in an attempt to open a new financial account (e.g., checking, savings, brokerage, etc.) with the financial institution. As another example, a resource request may be submitted in an attempt to open another resource, such as a line of credit, loan, or the like.

In some embodiments, a resource request may be submitted or otherwise associated with a new customer that is previously unaffiliated with the financial institution. For example, a new customer may not have any previous connection to the financial institution (e.g., no previously opened accounts, etc.). In some embodiments, a resource request may be submitted or otherwise associated with an existing customer having an established relationship with the financial institution (e.g., the existing customer already possesses an account with the financial institution or otherwise has some relationship to the financial institution through one or more resources). In some embodiments, existing customers may enter into an agreement with the financial institution to collect location data periodically (e.g., while the mobile banking application is being used) for various purposes. In this regard, historical location data may be collected from remote devices of customers and stored for various purposes (e.g., via GPS chips of remote devices). As further discussed herein, historical location data may be utilized in some instances to determine whether to authorize access to an electronic resource indicated by a resource request.

In some embodiments, a user may input data into fields displayed on a graphical user interface (GUI) of their mobile banking application on their personal remote device in order to provide personal information, upload documents, and the like to prove their identity, such that the financial institution can comply with KYC regulations and prevent fraud. In some embodiments, the personal information (e.g., PII) provided to the mobile banking application may include a plurality of attributes relating to the user. Such attributes may include, for example, first and last name, home address, work address, previous home and/or work addresses (e.g., over the previous three years, for example), contact information (phone number, email address, etc.), emergency contact information (e.g., name and address of the emergency contact, phone number of the emergency contact, etc.), date of birth, social security number, driver's license number and/or passport number, employment status, employer name, annual income, and the like. As mentioned above, a user may also upload proof of identity documents, such as proof of address documents (e.g., utility bills, mortgage closing disclosure, rental agreements, etc.), bank statements and/or paystubs, and the like.

In various embodiments, a resource request may be received from a remote device and by resource system 102 over the communications network 104. As mentioned above, a resource request may be received in response to a user submitting an application for an electronic resource (e.g., a new banking account, or the like). In various embodiments, a resource request comprises an electronic data structure including data indicating the plurality of attributes (e.g., text strings) which the resource system 102 can then leverage to parse and further process the data. Additionally, in some embodiments, the resource request may comprise a timestamp indicating a date and time at which the resource request was generated by the remote device. This timestamp may be used by resource system 102 to verify authenticity of location data as further discussed below.

As shown by operation 304 (in broken lines as this operation may be optional), the apparatus 200 may include means, such as processor 202, memory 204, communications hardware 206, and/or the like, for causing presentation of a prompt at the remote device requesting that current location data be shared. The presentation of the prompt may occur in several circumstances. For example, in the event that the user associated with the resource request (e.g., the user for which the requested resource is intended) is a new customer of the financial institution not having a previous affiliation with the financial institution, the prompt may be presented as the user has not previously granted or declined permission for the resource system 102 to collect location data from the remote device. The same may be true for an existing customer who has not previously granted or declined permission for the resource system 102 to collect location data from the remote device. However, in the event that the user associated with the resource request (e.g., the user for which the requested resource is intended) is an existing customer of the financial institution, the prompt may not be presented as the user has already previously granted permission for the resource system 102 to collect location data from the remote device.

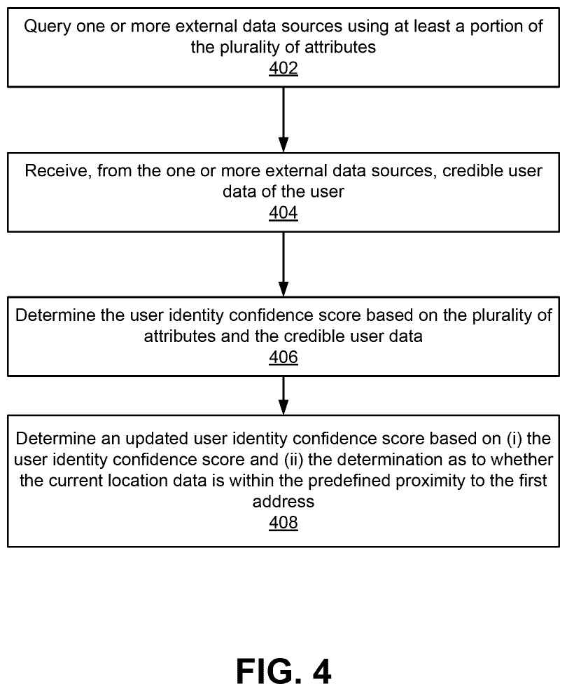

More generally, however, as further described below in connection with FIG. 4, the reception and processing of current location data may be a component of a larger resource grant determination process that involves only collecting and processing current location data in the event that the resource system 102 is unable to confidently verify the identity of the user through traditional approaches involved in the resource grant determination process. Thus, in some embodiments, operations 304-310 may only be performed in the event that the resource system 102 is otherwise unable to confidently verify the identity of the user.

In some embodiments, the prompt may be presented at the remote device in the form of a push notification (e.g., via the mobile banking application), in a text message, email, or other message of form of communication. In response to the prompt, a user of the remote device may provide an affirmative response (allowing location data of the remote device to be shared) or a negative response (not allowing location data of the remote device to be shared). In this regard, in some embodiments, current location data may be received by the resource system 102 via the GPS chip (e.g., GPS chip 228) of the remote device in response to an affirmative response to the prompt at the remote device.

As shown by operation 306, the apparatus 200 includes means, such as processor 202, memory 204, communications hardware 206, and/or the like, for receiving, via a GPS chip of the remote device, current location data associated with the remote device. As described above, a GPS chip (e.g., GPS chip 228) of the remote device may comprise an antenna that captures satellite signals over certain frequency bands, and a chipset which processes the received signals, corrects errors, and determines a real-time current location of the remote device. In some embodiments, communications hardware 226, processor 222, and/or memory 224 may be utilized by the GPS chip 228 to cause transmission of current location data associated with the remote device to resource system 102 using communications hardware 226 over communications network 104. The resource system 102 may then utilize communications hardware 206 to receive the current location data associated with the remote device.

In some embodiments, as mentioned above, the current location data may be secured prior to transmission via a protocol (e.g., TLS) to prevent tampering. In some embodiments, resource system 102 may process received current location data from a remote device for anomalies prior to additional operations to ensure authenticity of the data. To do so, authentication engine 208 may use one or more techniques for recognizing GPS spoofing, including for example one or more spatial anomaly detection algorithms. In some embodiments, current location data may comprise a set (e.g., two or more) of locations of the remote device captured at different times (e.g., different times over a predefined time interval, such as 10 seconds), and authentication engine 208 may process the received current location data to check for unrealistic speeds or sudden, significant changes in location based on the set of locations.

In some embodiments, current location data may include a cryptographically verifiable location signature which authentication engine 208 can process to ensure that the current location data was not spoofed or otherwise tampered with. For example, in some embodiments, GPS chip 228 of the remote device may receive location and timing data and a digital signature from one or more satellites (e.g., as part of the resource request). The digital signature may be generated using public-key cryptography, and the remote device can in turn verify the signature against the satellite's public key. The resource system 102 receiving the current location data may require the remote device to provide proof verifying that the data came from an actual satellite and not a spoofed source. This proof may comprise the remote device digitally signing the current location data (which includes authenticated navigation data including signed messages, timestamps, and verification results) using a private cryptographic key stored in a Trusted Execution Environment (TEE) of the remote device. A TEE is a secure area of a main processor (e.g., processor 222 of the remote device). A TEE protects code and data loaded inside it with respect to confidentiality and integrity. Data confidentiality prevents unauthorized entities from outside the TEE from reading data, while code integrity prevents code in the TEE from being replaced or modified by unauthorized entities, which may also be the device owner itself. This is done by implementing unique, immutable, and confidential architectural security, which offers hardware-based memory encryption that isolates specific application code and data in memory. This allows user-level code to allocate private regions of memory, called enclaves, which are designed to be protected from processes running at higher privilege levels. A TEE as an isolated execution environment provides security features such as isolated execution, integrity of applications executing with the TEE, and confidentiality of their assets.

Once received by resource system 102, the authentication engine 208 may determine whether the received GNSS data contains valid digital signatures from authentic satellites, and that the digital signature is correct and was not modified during transmission. To do so, resource system 102 may retrieve the public key associated with the specific GNSS satellite from a trusted database (e.g., a database associated with one or more external data sources 108A-108N). Authentication engine 208 may then use a digital signature verification algorithm to verify the signature. An example digital signature verification algorithm that is used may be ECDSA-256, for example. If the verification passes (e.g., the function returns True), the resource system 102 may consider the data as having originated from an authentic satellite.

Authentication engine 208 may also determine whether the timestamp in in an acceptable range, e.g., that the timestamp indicated by the current location data is within a predefined range of a timestamp at which the resource request was generated. As one example, the timestamp may be determined to be within an acceptable range if it matches or if the difference between the timestamp of the current location data and the timestamp of the resource request is within a few (e.g., 5-10) seconds. Additionally, the authentication engine 208 may also determine whether the remote device digitally signed the location data correctly. To do so, resource system 102 may retrieve the public key of the remote device from a trusted certificate authority (CA) or the like (e.g., one of external data sources 108A-108N) and use a verification function (e.g., ECDSA) to confirm the digital signature.

To summarize the above, in some embodiments, resource system 102 may process the current location data received from the remote device to determine (i) whether the current location data originated from an authentic satellite(s), (ii) whether the timestamp indicated by the current location data is within a predefined range of a timestamp at which the resource request was generated, and (iii) whether the remote device digitally signed the location data correctly. In some embodiments, if the resource system 102 determines a discrepancy with respect to any of these factors, the resource system 102 may prompt the remote device to inform a user of the remote device that the current location data is insufficient and request that the user associated with the resource request visit a physical bank branch to provide additional proof of identity and continue the resource request process. In some embodiments, the prompt may be presented at the remote device in the form of a push notification (e.g., via the mobile banking application), in a text message, email, or other message of form of communication. In some embodiments, if the resource system 102 determines that the current location data is authentic (e.g., that the factors described above do not indicate any discrepancies), the process may continue to operation 308.

As shown by operation 308, the apparatus 200 includes means, such as processor 202, memory 204, communications hardware 206, authentication engine 208, and/or the like, for determining, by an authentication engine, whether the current location data is within a predefined proximity to the first address. To do so, in some embodiments, resource system 102 may compare the current location data with the first address indicated by the resource request. In some embodiments, the first address indicated by the resource request may be in a format different from a format of the current location data. For example, in some embodiments, the first address of the resource request may be in a textual format (e.g., a text string, or human-readable characters in an encoding scheme such as UTF-8 or the like) such as “123 Main St., City, State, Zip Code,” while the current location data may be in a different format, such as a spatial coordinate format (e.g., latitude and longitude coordinates, and/or the like).

In some embodiments, in order to compare the current location data with the first address indicated by the resource request to determine whether the current location data is within a predefined proximity to the first address, resource system 102 may convert the first address into a format that aligns with the format of the current location data. In this regard, in some embodiments, the apparatus 200 includes means, such as processor 202, memory 204, location engine 212, and/or the like, for converting the first address into a spatial coordinate format prior to determining whether the current location data is within the predefined proximity to the first address. To do so, resource system 102 may perform a geocoding process using location engine 212. In some embodiments, this process may involve first tokenizing the address to identify components of the address (e.g., street name, street number, city, state, zip code, country, etc.), standardizing the tokens (e.g., converting any abbreviations to full words), and ensuring no empty fields or other input-related errors.

In some embodiments, the resource system 102, using location engine 212 and/or communications hardware 206, may utilize one or more external data sources (e.g., one of external data sources 108A-108N), such as a geospatial database or server associated with a geospatial database to search for the address and identify spatial coordinates aligning with the address. In some embodiments, this may involve using a geocoding Application Programming Interface (API) and generating and sending a Hypertext Transfer Protocol (HTTP) request that includes the address to a geocoding API. In response, resource system 102 may receive (via communications hardware 206) a response that includes spatial coordinates corresponding to the address. This response may be in a particular format, such as JavaScript Object Notation (JSON) or the like, and resource system 102 may extract the coordinates in order to determine whether the current location data is within a predefined proximity to the first address.

Additionally, in some embodiments, in the event that the current location data received from remote device is not in a preferred spatial coordinate format of the resource system 102, resource system 102 may convert the current location data into a different format. In this regard, in some embodiments, the apparatus 200 includes means, such as processor 202, memory 204, location engine 212, and/or the like, for converting the current location data into the spatial coordinate format prior to determining whether the current location data is within the predefined proximity to the first address. For example, in some embodiments, resource system 102 may convert both the first address indicated in the resource request and the current location data into a latitude/longitude format for comparison (though it is to be appreciated that a different spatial coordinate format may be utilizing in carrying out example embodiments described herein). In the event the current location data is in a format other than latitude/longitude, the resource system 102 may utilize location engine 212 and/or communications hardware 206 to convert the current location data into a preferred format (e.g., latitude/longitude). For example, in some instances, current location data of a remote device may be received in Degrees, Minutes, Seconds (DMS) format, Universal Transverse Mercator (UTM) format, or the like, rather than latitude/longitude.

In some embodiments, in order to determine whether the current location data is within a predefined proximity to the first address (i.e., whether the remote device is currently present at the first address), resource system 102 may utilize one or more coordinate comparison methods. As one example, resource system 102 may determine whether spatial coordinates corresponding to the current location data fall within a circular radius (of a predefined distance) of spatial coordinates corresponding to the first address. In this manner, authentication engine 208 may utilize the Haversine Formula to compute the shortest distance between two latitude/longitude points. If the distance output from the Haversine Formula is less than or equal to the predefined distance, the resource system 102 may consider the remote device to be within adequate range of the first address. It is to be appreciated that other types of coordinate comparisons may be utilized in addition (or alternatively) to Haversine Formula. For example, authentication engine 208 may utilize a bounding box calculation, point-in-polygon (PIP) algorithm, and/or the like to determine whether the current location data is within a predefined proximity to the first address.

As shown by operation 310, the apparatus 200 includes means, such as processor 202, memory 204, communications hardware 206, resource management engine 210, and/or the like, for facilitating, by resource management engine, access to a first electronic resource based at least on the determination. In various embodiments, facilitating access to an electronic resource may comprise granting access to an electronic resource (e.g., approving the resource request for a new checking account or other electronic resource) or denying access to an electronic resource (e.g., denying the resource request for a new checking account or other electronic resource). In this regard, in some embodiments, resource management engine 210 may grant access to the electronic resource if it is determined that the current location data is within the predefined proximity to the first address. In some embodiments, granting access to the electronic resource may comprise initiating one or more downstream operations of the resource system 102 and/or other systems connected to resource system 102 (e.g., other systems of a financial institution) to proceed with opening the electronic resource and/or the like. In some embodiments, resource management engine 210 may deny access to the electronic resource if it is determined that the current location data is not within the predefined proximity to the first address. In some embodiments, denying access to the electronic resource may comprise prompting the remote device to inform a user of the remote device that the current location data is insufficient and request that the user associated with the resource request visit a physical bank branch to provide additional proof of identity and continue the resource request process. In some embodiments, the prompt may be presented at the remote device in the form of a push notification (e.g., via the mobile banking application), in a text message, email, or other message of form of communication.

In some embodiments, the operations described above and outlined in FIG. 3 may be components of a larger resource grant determination process conducted by an entity associated with the resource system 102 (e.g., a financial institution) which factors in other identity authentication processes in addition to collecting current location data and determining whether the current location data is within a predefined proximity to the first address. In some embodiments, the resource grant determination process may be carried out to authenticate the identity of the individual for which the requested resource is intended. For example, in some embodiments, the resource grant determination process may include verifying other attributes of the plurality of attributes indicated by the resource request. As explained below in connection with FIG. 4, attributes of the individual may be checked against credible data from one or more external data sources in order to confirm accuracy of the data in the resource request. In this regard, in some embodiments, the apparatus 200 includes means, such as processor 202, memory 204, communications hardware 206, resource management engine 210, and/or the like, for performing a resource grant determination process using at least a portion of the plurality of attributes. In some embodiments, resource system 102 may determine a user identity confidence score as a result of the resource grant determination process. In some embodiments, resource management engine 210 may perform the resource grant determination process prior to receiving the current location data associated with the remote device. That is, in some embodiments, operations 304-310 may be performed only in the event of an unsatisfactory result of the resource grant determination process, e.g., the resource grant determination process resulting in a user identity confidence score failing to satisfy a predefined threshold, as further described below. However, in some embodiments, operations 304-310 may be performed regardless of the outcome of the resource grant determination process (e.g., for additional authentication of the individual for which the requested resource is intended).

Turning to FIG. 4, example operations are shown for an example resource grant determination process.

As shown by operation 402, the apparatus 200 includes means, such as processor 202, memory 204, communications hardware 206, authentication engine 208, and/or the like, for querying one or more external data sources using at least a portion of the plurality of attributes. For example, resource system 102 may communicate with one or more external data sources, e.g., a credit bureau or similar institution, over communications network 104 in order to obtain credible user data. In this regard, authentication engine 208 may package a request comprising a portion (or all) of the plurality of attributes of the resource request. These attributes may include, for example, first and last name, home address, work address, previous home and/or work addresses, phone number, email address, date of birth, social security number, driver's license number and/or passport number, employment status, employer name, annual income, and the like. In some embodiments, authentication engine 208 may preprocess the attributes to ensure consistency prior to querying the one or more external data sources. This may include, for example, standardizing addresses, formatting dates, and partially obfuscating certain information (e.g., portions of a social security number). The request may then be transmitted (e.g., using communications hardware 206) to one or more external data sources. For example, the request may be transmitted to a credit bureau using an API over the TLS protocol. As another example, the request may be communicated via Secure File Transfer Protocol (SFTP), which allows for secure transfer of files over the internet and uses encryption and cryptographic hash functions to protect integrity of the data.

As shown by operation 404, the apparatus 200 includes means, such as processor 202, memory 204, communications hardware 206, and/or the like, for receiving, from the one or more external data sources, credible user data of the user. Once the credit bureau (or other external data source) executes a lookup against their database (e.g., matching attributes against credit history and other records, the credit bureau may communicate a response in the form of credible user data back to resource system 102. In some embodiments, credible user data may comprise responses to various attributes of the plurality of attributes. For example, the credit bureau may not inform the financial institution of actual PII of the individual, but rather, provide information on whether a given attribute is true or false. For example, a date of birth listed for the individual may be indicated as ‘true’ in the credible user data, whereas a phone number may be indicated as ‘false’ (e.g., the user inputting attributes for the resource request provided an incorrect phone number for the intended individual). In some embodiments, the credible data may also include a confidence score determined by the credit bureau or other external data source. For example, the confidence score may represent how well the attributes provided in the resource request match authoritative records. As one example, the confidence score may be a number between 0-100, with 100 indicating an exact match of all attributes, and 0 indicating a match of no attributes.

As shown by operation 406, the apparatus 200 includes means, such as processor 202, memory 204, authentication engine 208, and/or the like, for determining the user identity confidence score based on the plurality of attributes and the credible user data. In some embodiments, if a confidence score was provided by the external data source as mentioned above, authentication engine 208 may use that confidence score as the user identity confidence score. In some embodiments, however, authentication engine 208 may determine the user identity confidence score by weighing various attributes and the responses to those attributes indicated by the credible user data received at operation 404. In some embodiments, this may involve utilizing a scoring algorithm to assign points to certain attributes. As an example, a social security number may be weighed heavier than a phone number, and receive 20 points for being correct (e.g., the credible data returned ‘true’ for the social security number indicating that the correct social security number was provided), while a correct phone number is assigned 10 points. In some embodiments, user identity confidence score may comprise the sum of points assigned to the attributes.

In some embodiments, if the user identity confidence score satisfies a predefined threshold, the resource system 102 may grant access to the electronic resource associated with the resource request. As one example, if the user identity confidence score meets or exceeds 90, the resource system 102 may grant access to the electronic resource associated with the resource request. However, as noted above, in some embodiments, if the user identity confidence score fails to satisfy the predefined threshold, additional operations may be performed as part of the resource grant determination process, such as operations 306-310. In this regard, resource system 102 may request and receive the current location data of the remote device, determine whether the current location data is within a predefined proximity to the first address, and update the user identity confidence score based on the determination. In this regard, as shown by operation 408, the apparatus 200 includes means, such as processor 202, memory 204, communications hardware 206, authentication engine 208, and/or the like, for determining an updated user identity confidence score based on (i) the user identity confidence score and (ii) the determination as to whether the current location data is within the predefined proximity to the first address. In this regard, if it is determined that the current location data is within the predefined proximity to the first address, the user identity confidence score may be increased by a predefined number, and in turn re-assessed to determine whether to grant or deny the resource request. Continuing with the example above, a user identity score of 88 may be increased by a predefined number (e.g., 5) based on the current location data of the remote device being within the predefined proximity to the first address. Thus, the updated user identity score of 93 passes the predefined threshold and access to the electronic resource may then be granted.

In some embodiments, as mentioned above, if it is determined that the current location data is not within the predefined proximity to the first address, the remote device may be prompted to request that the user visit a physical branch to continue the request process. This may be carried out in instances in which the individual for which the requested resource is intended is a new customer to the financial institution (e.g., not having a previous affiliation with the financial institution). However, in some embodiments, a different approach may be taken in the event that the individual for which the requested resource is intended is an existing customer of the financial institution (e.g., an existing customer having an established relationship with the financial institution, having one or more accounts or other products associated with the financial institution, etc.) and has previously provided location data from their remote device at various times over a previous time period. In these circumstances, historical location data of the remote device may be utilized as an additional check to determine how to facilitate access to the requested electronic resource. As one example, an existing customer may be on vacation or otherwise located somewhere different from their home address at the time the resource request was generated and transmitted to resource system 102, and thus it may be determined that the current location data is not within the predefined proximity to the first address. However, because this is an existing customer (i.e., a trusted user, recognized for example through a system of record associated with the resource system 102), in some embodiments, resource system 102 may take additional steps to authenticate the identity of the individual through historical location data.

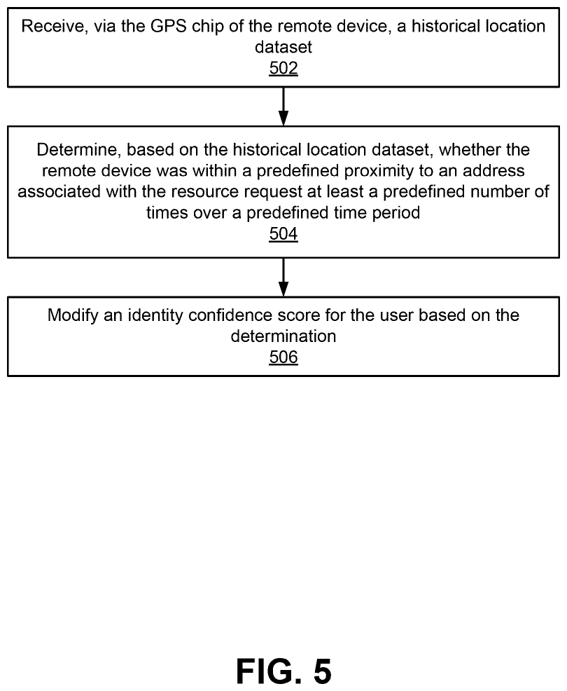

Turning to FIG. 5, example operations are shown for modifying a user identity confidence score based on a historical location dataset.

As shown by operation 502, the apparatus 200 includes means, such as processor 202, memory 204, communications hardware 206, and/or the like, for receiving, via the GPS chip of the remote device, a historical location dataset. As mentioned above, an existing customer may have previously entered into an agreement with the financial institution to allow collection of location data from their personal device periodically (e.g., while the mobile banking application is being used) for various purposes. In this regard, historical location data may be collected by the resource system 102 or another entity associated with the resource system 102 (e.g., another server, device, or the like) from the remote device over a period of time and stored (e.g., in memory 204 and/or a database associated with resource system 102). In this manner, in some embodiments, receiving the historical location dataset may comprise retrieving the historical location dataset associated with the particular remote device from memory. In other embodiments, for example, a historical location dataset may be retrieved from memory or other storage on remote device 106A (e.g., the remote device may provide a historical location dataset of the remote device that is stored at the remote device (e.g., in memory 224)).

In various embodiments, a historical location dataset may comprise a plurality of technical attributes corresponding to various locations visited and movements made by the remote device over a specific time period (e.g., the previous 30 days, the previous 90 days, etc.). These attributes may include, for example, location attributes such as latitude and longitude coordinates, altitude and speed measurements, and movement direction, along with temporal attributes such as timestamps corresponding to a time and date at which a data point (e.g., a current latitude/longitude) was recorded. Other attributes may also be included in a historical location dataset, such as contextual information including nearby or connected networks at the time (e.g., Wi-Fi networks and/or cellular towers) and associated signal strength data, orientation, and/or motion states of the remote device at a particular time. In some embodiments, resource system 102 may utilize these additional attributes to verify that the location recorded at given times included in the historical location dataset was not spoofed.

In various embodiments, the historical location dataset may be stored in a tabular format (e.g., Comma-Separated Values (. CSV) format or the like) or a database format (e.g., structured query language (SQL), MongoDB, or the like) such that the resource system 102 may execute queries over the data to efficiently location relevant location data needed by the resource system 102 as further described below.

As shown by operation 504, the apparatus 200 includes means, such as processor 202, memory 204, communications hardware 206, authentication engine 208 and/or the like, for determining, based on the historical location dataset, whether the remote device was within a predefined proximity to the first address at least a predefined number of times over a predefined time period. In some embodiments, for example, authentication engine may utilize the first address in the spatial coordinate format to generate and execute queries configured to return location records that indicate points in time at which the remote device was geographically near or within a proximity to the first address (e.g., within a predefined geofence of the first address). This operation may be performed to determine whether the device was located at the individual's home a sufficient number of unique times as well as amount of time in line with a typical amount of time that a personal device would be present at the home over the period of time. In this regard, the authentication engine 208 may determine (e.g., using one or more queries executed over the historical location dataset) a number of unique visits to the first address as well as the duration of those visits. As just one example, the authentication engine 208 can verify if the device was present at the first address at least twenty times over the previous thirty days, and that at least ten of those times were for more than five-hour durations. It is to be appreciated that other predefined time periods, number of visits, and durations may be used.

In some embodiments, in addition or as an alternative to determining, based on the historical location dataset, whether the remote device was within a predefined proximity to the first address at least a predefined number of times over a predefined time period, the authentication engine 208 may determine, based on the historical location dataset, whether the remote device was within a predefined proximity to at least one secondary address indicated by the resource request at least a predefined number of times over a predefined time period. For example, spatial coordinates for another address contained in the resource request, such as work address corresponding to the individual's employer, may also be used to generate and execute queries configured to return location records that indicate points in time at which the remote device was geographically near or within a proximity to the work address (e.g., within a predefined geofence of the work address). This operation may be performed to determine whether the device was located at their place of employment a sufficient number of unique times as well as amount of time in line with a typical amount of time that a personal device would be present at work the period of time. Like described above, the authentication engine 208 may determine (e.g., using one or more queries executed over the historical location dataset) a number of unique visits to the secondary address as well as the duration of those visits.

As shown by operation 506, the apparatus 200 includes means, such as processor 202, memory 204, communications hardware 206, authentication engine 208, and/or the like, for modifying a user identity confidence score for the user based on the determination. For example if it is determined that the remote device was within a predefined proximity to the first address at least a predefined number of times over a predefined time period, the user identity confidence score may be increased by a predefined number, and in turn re-assessed to determine whether to grant or deny the resource request. Continuing with the example discussed earlier, a user identity score of 88 may be increased by a predefined number (e.g., 5) based on the remote device having been within a predefined proximity to the first address at least a predefined number of times over a predefined time period. Thus, the updated user identity score of 93 passes the predefined threshold and access to the electronic resource may then be granted.

In some embodiments, as mentioned above, if it is determined that the remote device was not within a predefined proximity to the first address at least a predefined number of times over a predefined time period, the user identify confidence score may be modified by decreasing the user identity confidence score by a certain amount and/or the remote device may be prompted to request that the user visit a physical branch to continue the request process.

FIGS. 3-5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method comprising:
receiving, by communications hardware and from a remote device, a resource request comprising a plurality of attributes relating to a user including a first attribute indicating a first address of the user;
receiving, by the communications hardware and via a GPS chip of the remote device, current location data associated with the remote device;
determining, by an authentication engine, whether the current location data is within a predefined proximity to the first address; and
facilitating, by a resource management engine, access to a first electronic resource based at least on the determination.

2. The computer-implemented method of claim 1, wherein the first address is in a textual format, and wherein the computer-implemented method further comprises:
converting, by a location engine, the first address into a spatial coordinate format prior to determining whether the current location data is within the predefined proximity to the first address.

3. The computer-implemented method of claim 2, further comprising:
converting, by the location engine, the current location data into the spatial coordinate format prior to determining whether the current location data is within the predefined proximity to the first address.

4. The computer-implemented method of claim 1, further comprising:
causing, by the communications hardware, presentation of a prompt at the remote device requesting that the current location data be shared,
wherein the current location data is received via the GPS chip of the remote device in response to an affirmative response to the prompt at the remote device.

5. The computer-implemented method of claim 1, further comprising:
performing, by the resource management engine and prior to receiving the current location data associated with the remote device, a resource grant determination process using at least a portion of the plurality of attributes,
wherein the current location data is received in response to the resource grant determination process resulting in a user identity confidence score failing to satisfy a predefined threshold.

6. The computer-implemented method of claim 5, further comprising:
determining, by the authentication engine, an updated user identity confidence score based on (i) the user identity confidence score and (ii) the determination as to whether the current location data is within the predefined proximity to the first address,
wherein the access to the first electronic resource is facilitated based further on the updated user identity confidence score.

7. The computer-implemented method of claim 5, wherein performing the resource grant determination process comprises:
querying, by the authentication engine, one or more external data sources using at least a portion of the plurality of attributes;
receiving, by the communications hardware and from the one or more external data sources, credible user data of the user; and
determining, by the authentication engine, the user identity confidence score based on the plurality of attributes and the credible user data.

8. The computer-implemented method of claim 1, further comprising:
receiving, by the communications hardware and via the GPS chip of the remote device, a historical location dataset;
determining, by the authentication engine and based on the historical location dataset, whether the remote device was within a predefined proximity to the first address at least a predefined number of times over a predefined time period; and
modifying, by the authentication engine, a user identity confidence score for the user based on the determination.

9. The computer-implemented method of claim 8, further comprising:
determining, by the authentication engine and based on the historical location dataset, whether the remote device was within a predefined proximity to at least one secondary address indicated by the resource request at least a predefined number of times over a predefined time period; and
modifying, by the authentication engine, the user identity confidence score for the user based on the determination.

10. The computer-implemented method of claim 1, wherein the resource request is a request to open a new financial account with a financial institution, and wherein the first electronic resource comprises the new financial account.

11. An apparatus comprising:
communications hardware configured to:
receive, from a remote device, a resource request comprising a plurality of attributes relating to a user including a first attribute indicating a first address of the user, and
receive, via a GPS chip of the remote device, current location data associated with the remote device;
an authentication engine configured to determine whether the current location data is within a predefined proximity to the first address; and
a resource management engine configured to facilitate access to a first electronic resource based at least on the determination.

12. The apparatus of claim 11, wherein the first address is in a textual format, and wherein the apparatus further comprises:
a location engine configured to convert the first address into a spatial coordinate format prior to determining whether the current location data is within the predefined proximity to the first address.

13. The apparatus of claim 11, wherein the communications hardware is further configured to cause presentation of a prompt at the remote device requesting that the current location data be shared,
wherein the current location data is received via the GPS chip of the remote device in response to an affirmative response to the prompt at the remote device.

14. The apparatus of claim 11, wherein the resource management engine is further configured to perform, prior to receiving the current location data associated with the remote device, a resource grant determination process using at least a portion of the plurality of attributes,
wherein the current location data is received in response to the resource grant determination process resulting in a user identity confidence score failing to satisfy a predefined threshold.

15. The apparatus of claim 14, wherein the authentication engine is further configured to determine an updated user identity confidence score based on (i) the user identity confidence score and (ii) the determination as to whether the current location data is within the predefined proximity to the first address,
wherein the access to the first electronic resource is facilitated based further on the updated user identity confidence score.

16. The apparatus of claim 14, wherein the resource grant determination process comprises:
querying one or more external data sources using at least a portion of the plurality of attributes;
receiving, from the one or more external data sources, credible user data of the user; and
determining the user identity confidence score based on the plurality of attributes and the credible user data.

17. The apparatus of claim 11,
wherein the communications hardware is further configured to receive, via the GPS chip of the remote device, a historical location dataset, and
wherein the authentication engine is further configured to:
determine, based on the historical location dataset, whether the remote device was within a predefined proximity to the first address at least a predefined number of times over a predefined time period, and
modify a user identity confidence score for the user based on the determination.

18. The apparatus of claim 17, wherein the authentication engine is further configured to:
determine, based on the historical location dataset, whether the remote device was within a predefined proximity to at least one secondary address indicated by the resource request at least a predefined number of times over a predefined time period, and
modify the user identity confidence score for the user based on the determination.

19. The apparatus of claim 11, wherein the resource request is a request to open a new financial account with a financial institution, and wherein the first electronic resource comprises the new financial account.

20. A computer program product comprising at least one non-transitory computer-readable storage medium storing software instructions that, when executed, cause an apparatus to:
receive, from a remote device, a resource request comprising a plurality of attributes relating to a user including a first attribute indicating a first address of the user;
receive, via a GPS chip of the remote device, current location data associated with the remote device;
determine whether the current location data is within a predefined proximity to the first address; and
facilitate access to a first electronic resource based at least on the determination.
